(19) United States
(12) Patent Application Publication
(10) Pub. No.: US 2026/0333195 A1
(43) Pub. Date: Oct. 22, 2026

(54) VEHICLE, INFORMATION PROCESSING APPARATUS, SYSTEM, AND COMMUNICATION RESTRICTION METHOD

(71) Applicant: TOYOTA JIDOSHA KABUSHIKI KAISHA, Toyota-shi (JP)

(72) Inventor: Ayako TAKIZAKI, Okazaki-shi (JP)

(73) Assignee: TOYOTA JIDOSHA KABUSHIKI KAISHA, Toyota-shi (JP)

(21) Appl. No.: 19/468,597

(22) Filed: Feb. 3, 2026

(30) Foreign Application Priority Data
Feb. 6, 2025 (JP) 2025-018759

(51) Int. Cl. H04W 48/08; H04W 12/64; H04W 28/06

(52) U.S. Cl. CPC H04W 48/08; H04W 12/64; H04W 28/06

(57) ABSTRACT

An information processing apparatus includes a control unit. The control unit is configured to control a plurality of connected functions of a vehicle configured to communicate with an external server apparatus. The plurality of connected functions is configured to transmit, to the server apparatus, pieces of information respectively corresponding to the plurality of connected functions from among two or more types of information collected by the vehicle. The control unit is configured to, in response to receiving, via an input device mounted on the vehicle, user input designating a type of information to be prohibited from being transmitted to an outside of the vehicle as a prohibited type, restrict the connected function that transmits information of the prohibited type to the server apparatus among the plurality of connected functions.

### CROSS-REFERENCE TO RELATED APPLICATION

This application claims priority to Japanese Patent Application No. 2025-018759 filed on Feb. 6, 2025. The disclosure of the above-identified application, including the specification, drawings, and claims, is incorporated by reference herein in its entirety.

### BACKGROUND

### 1. Technical Field

The disclosure relates to a vehicle, an information processing apparatus, a system, and a communication restriction method.

### 2. Description of Related Art

Japanese Unexamined Patent Application Publication No. 2020-135813 (JP 2020-135813 A) describes an apparatus that displays a screen prompting a user in a vehicle to select whether to consent to the provision of information and, when the user consents to the provision of information, transmits the information to the outside of the vehicle.

### SUMMARY

When transmission of information to the outside of the vehicle is uniformly restricted, it is inconvenient for the user.

The disclosure enables transmission of information to the outside of a vehicle to be partially restricted in response to a user's request.

A first aspect of the disclosure relates to an information processing apparatus. The information processing apparatus includes a control unit configured to control a plurality of connected functions of a vehicle configured to communicate with an external server apparatus, the plurality of connected functions being configured to transmit, to the server apparatus, pieces of information respectively corresponding to the plurality of connected functions from among two or more types of information collected by the vehicle to cooperate with the server apparatus, the control unit being configured to, in response to receiving, via an input device mounted on the vehicle, user input designating a type of information to be prohibited from being transmitted to an outside of the vehicle as a prohibited type, restrict the connected function that transmits information of the prohibited type to the server apparatus among the plurality of connected functions.

A second aspect of the disclosure relates to a communication restriction method. The communication restriction method includes, by an information processing apparatus configured to control a plurality of connected functions of a vehicle configured to communicate with an external server apparatus, the plurality of connected functions being configured to transmit, to the server apparatus, pieces of information respectively corresponding to the plurality of connected functions from among two or more types of information collected by the vehicle to cooperate with the server apparatus, in response to receiving, via an input device mounted on the vehicle, user input designating a type of information to be prohibited from being transmitted to an outside of the vehicle as a prohibited type, restricting the connected function that transmits information of the prohibited type to the server apparatus among the plurality of connected functions.

According to the aspects of the disclosure, it is possible to partially restrict transmission of information to the outside of a vehicle in response to a user's request. Thus, compared to the case where transmission of information to the outside of the vehicle is uniformly restricted, the convenience improves.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram that shows the configuration of a system according to an embodiment of the disclosure;

FIG. 2 is a diagram that shows an example of a vehicle equipped with an information processing apparatus according to the embodiment of the disclosure;

FIG. 3 is a block diagram that shows connections between an in-vehicle device and the information processing apparatus according to the embodiment of the disclosure;

FIG. 4 is a diagram that shows an example in which transmission of information to the outside of the vehicle is not restricted;

FIG. 5 is a diagram that shows an example in which transmission of information to the outside of the vehicle is partially restricted;

FIG. 6 is a flowchart that shows the operation of the information processing apparatus according to the embodiment of the disclosure; and

FIG. 7 is a flowchart that shows a modification of the operation of the information processing apparatus according to the embodiment of the disclosure.

### DETAILED DESCRIPTION OF EMBODIMENTS

Hereinafter, an embodiment of the disclosure will be described with reference to the accompanying drawings.

Like reference signs denote the same or corresponding portions in the drawings. In the description of the present embodiment, the description of the same or corresponding portions is omitted or simplified as needed.

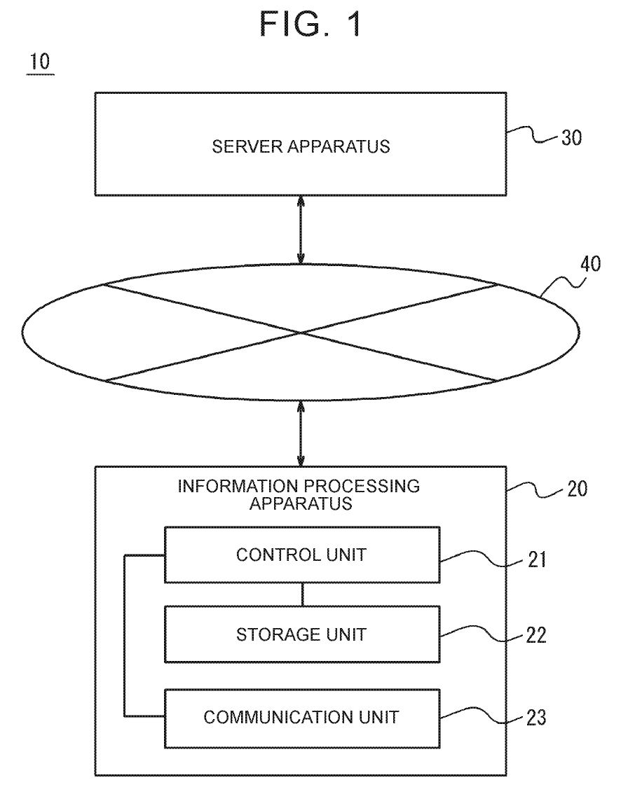

The configuration of a system 10 according to the present embodiment will be described with reference to FIG. 1.

The system 10 according to the present embodiment includes an information processing apparatus 20 and a server apparatus 30. The information processing apparatus 20 is capable of communicating with the server apparatus 30 via a network 40.

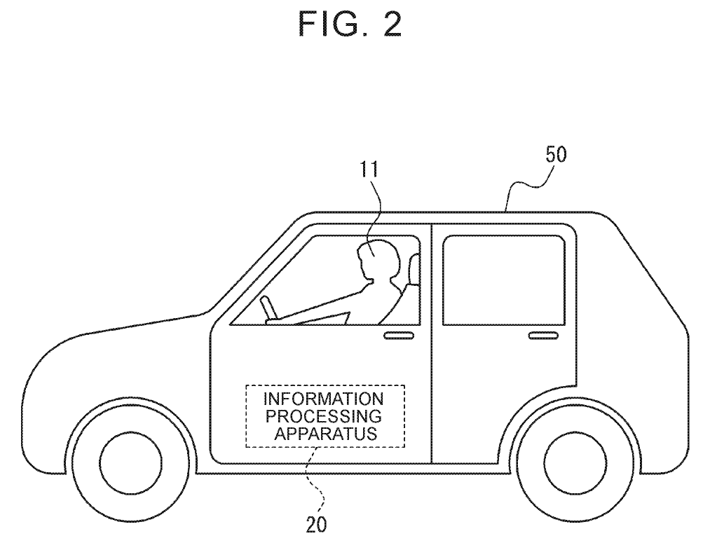

The information processing apparatus 20 may be a general-purpose computer such as a PC, a server computer such as a cloud server, or a dedicated computer. "PC” is an abbreviation for personal computer. As shown in FIG. 2, in the present embodiment, the information processing apparatus 20 is installed in a vehicle 50. In a modification, the information processing apparatus 20 may be installed in a place away from the vehicle 50, such as a data center, as long as the information processing apparatus 20 can communicate with various devices mounted on the vehicle 50.

The vehicle 50 is any type of vehicle, such as a gasoline vehicle, a diesel vehicle, a hydrogen vehicle, an HEV, a PHEV, a BEV, and an FCEV. "HEV” is an abbreviation for hybrid electric vehicle. "PHEV” is an abbreviation for plug-in hybrid electric vehicle. "BEV” is an abbreviation for battery electric vehicle. "FCEV” is an abbreviation for fuel cell electric vehicle. The vehicle 50 is driven by a user 11 in the present embodiment. Alternatively, the vehicle 50 may be automatically driven at a selected level. The level of automation is, for example, any one of level 1 to level 5 in SAE-defined levels. "SAE” is an abbreviation for Society of Automotive Engineers. The vehicle 50 may be a MaaS-dedicated vehicle. "MaaS” is an abbreviation for Mobility as a Service.

The server apparatus 30 is a server computer, such as a cloud server. The server apparatus 30 is installed in a facility, such as a data center.

The network 40 includes the Internet, at least one WAN, at least one MAN, or any combination of them. "WAN” is an abbreviation for wide area network. "MAN” is an abbreviation for metropolitan area network. The network 40 may include at least one wireless network, at least one optical network, or a combination of them. Examples of the wireless network include an ad hoc network, a cellular network, a wireless LAN, a satellite communication network, and a terrestrial microwave network. "LAN” is an abbreviation for local area network.

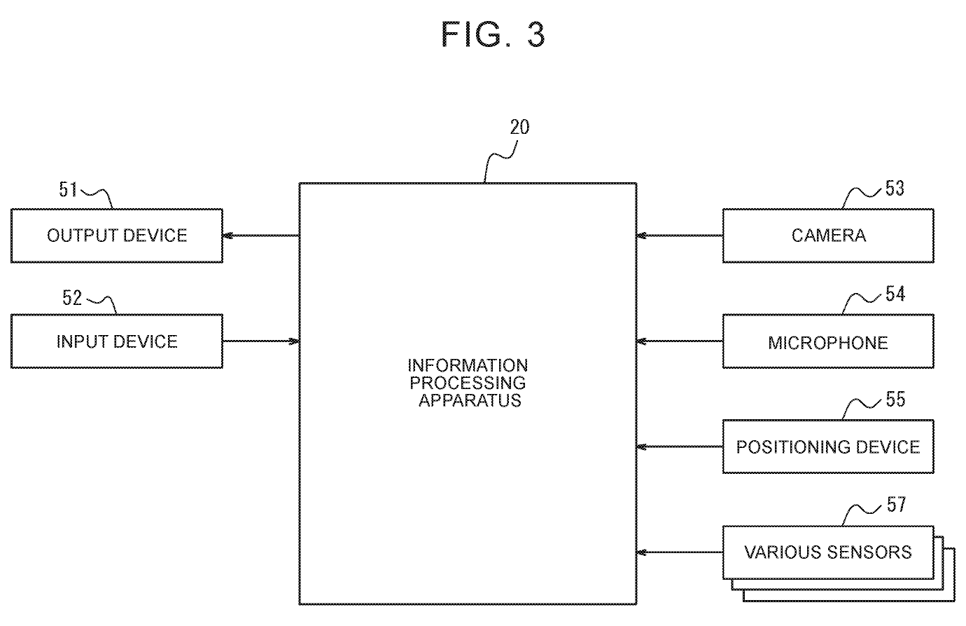

As shown in FIG. 3, in the present embodiment, the information processing apparatus 20 is connected to various devices mounted on the vehicle 50. The various devices include an output device 51, an input device 52, a camera 53, a microphone 54, a positioning device 55, various sensors 57, and the like. Interfaces that support standards, such as USB, HDMI (registered trademark), and Bluetooth (registered trademark), can be used as the interfaces for connecting to various devices. "USB” is an abbreviation for Universal Serial Bus. "HDMI (registered trademark)” is an abbreviation for High-Definition Multi media Interface. The information processing apparatus 20 may be connected to various devices via an in-vehicle network, such as a CAN. "CAN” is an abbreviation for Controller Area Network. In a modification, the information processing apparatus 20 may include one or more of the various devices mounted on the vehicle 50.

The output device 51 is, for example, a display or a speaker. The display is, for example, an LCD or an organic EL display. "LCD” is an abbreviation for liquid crystal display. "EL" is an abbreviation for electro luminescent. The display may also be a display audio. The output device 51 outputs information obtained through the operation of the information processing apparatus 20.

The input device 52 is, for example, a physical key, a capacitance key, a pointing device, or a touch screen provided integrally with a display. The camera 53, the microphone 54, or both may also serve as the input device 52. The input device 52 receives an operation to input information used in the operation of the information processing apparatus 20.

The camera 53 is, for example, a visible light camera or a depth camera. The camera 53 captures images of the inside, outside, or both of the vehicle 50. The camera 53 outputs image information that includes the captured images.

The microphone 54 collects sound from inside, outside, or both of the vehicle 50. The microphone 54 outputs audio information that includes the collected sound.

The positioning device 55 is, for example, a GNSS receiver. "GNSS" is an abbreviation for global navigation satellite system. GNSS is, for example, GPS, QZSS, BDS, GLONASS, or Galileo. "GPS” is an abbreviation for Global Positioning System. "QZSS” is an abbreviation for Quasi-Zenith Satellite System. The satellites of QZSS are called quasi-zenith satellites. "BDS” is an abbreviation for BeiDou Navigation Satellite System. "GLONASS” is an abbreviation for Global Navigation Satellite System. The positioning device 55 measures the coordinates of the vehicle 50, that is, the vehicle location. The positioning device 55 outputs location information that includes the measured vehicle location.

The various sensors 57 include, for example, a vehicle speed sensor, an acceleration sensor, a gyro, a motion sensor, and a door open-close sensor. The various sensors 57 observe different events at respective portions the vehicle 50. The various sensors 57 output vehicle information that includes the results of observations.

The outline of the present embodiment will be described with reference to FIGS. 1-3.

The information processing apparatus 20 controls a plurality of connected functions of the vehicle 50. The vehicle 50 is capable of communicating with the external server apparatus 30. The connected functions are functions that transmit pieces of information respectively corresponding to the connected functions, from among two or more types of information collected in the vehicle 50, to the server apparatus 30 to cooperate with the server apparatus 30. In response to receiving, via the input device 52 mounted on the vehicle 50, user input designating a type of information to be prohibited from being transmitted to the outside of the vehicle 50 as a prohibited type, the information processing apparatus 20 restricts the connected function that transmits information of the prohibited type to the server apparatus 30 among the plurality of connected functions.

According to the present embodiment, it is possible to partially restrict transmission of information to the outside of the vehicle 50 in response to a request from the user 11. Thus, compared to the case where transmission of information to the outside of the vehicle 50 is uniformly restricted, the convenience improves.

In the present embodiment, the information processing apparatus 20 collects four types of information including location information, audio information, image information, and vehicle information respectively obtained through the positioning device 55, the microphone 54, the camera 53, and the various sensors 57 mounted on the vehicle 50 as two or more types of information. The connected functions of the vehicle 50 are functions that transmit in real time different types of information respectively corresponding to the connected functions, from among the collected four types of information, to the server apparatus 30 to cooperate with the server apparatus 30.

In a modification, the information processing apparatus 20 may collect only three types of information from among the four types of information. In this modification, the connected functions of the vehicle 50 are functions that transmit in real time different types of information respectively corresponding to the connected functions, from among the collected three types of information, to the server apparatus 30 to cooperate with the server apparatus 30.

In another modification, the information processing apparatus 20 may collect only two types of information from among the four types of information. In this modification, the connected functions of the vehicle 50 are functions that transmit in real time different types of information respectively corresponding to the connected functions, from among the collected two types of information, to the server apparatus 30 to cooperate with the server apparatus 30.

As described above, the information handled by the connected functions of the vehicle 50 and transmitted to the server apparatus 30 includes personal information. With the establishment of privacy laws in various countries, including the European GDPR, obtaining the consent of the user 11 to transmission of personal information to the outside of the vehicle 50 and handling the personal information according to the intention of the user 11 can be indispensable. "GDPR” is an abbreviation for General Data Protection Regulation.

It is conceivable to protect privacy by blocking communication itself; however, this not only fails to reflect the intention of the user 11 based on the type of personal information but also restricts functions not to be restricted, such as eCall. "eCall” is an abbreviation for emergency call.

In the present embodiment, personal information is managed in units of location information, audio information, image information, and all personal information including these pieces of information, and transmission to the outside of the vehicle 50 is performed or stopped based on the settings of the user 11. Vehicle information is included in "all personal information”.

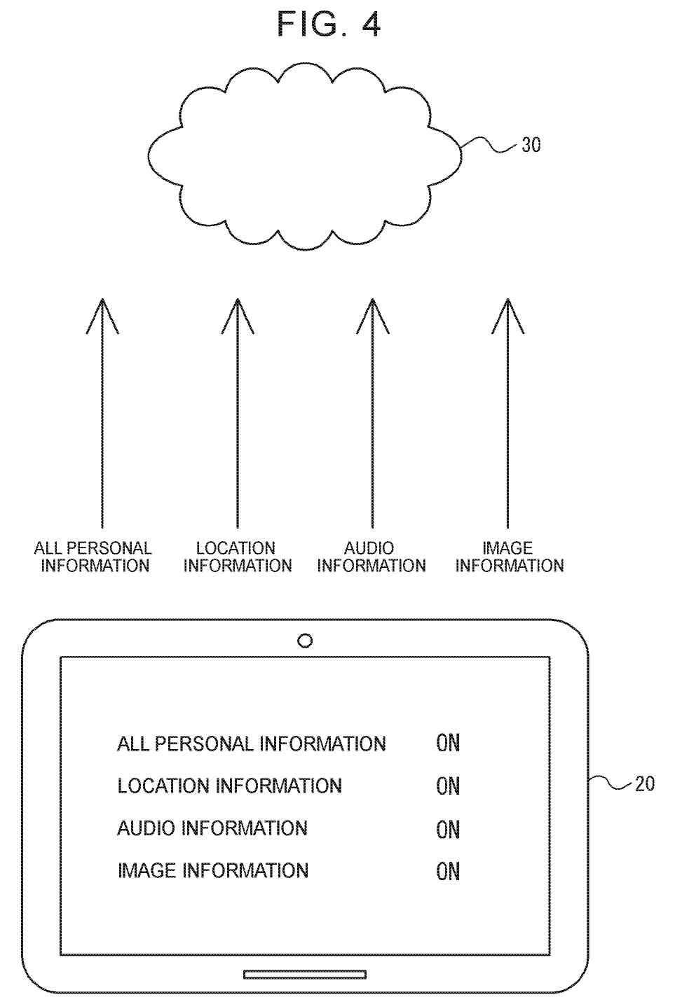

For example, as shown in FIG. 4, it is assumed that the user 11 has enabled transmission of location information, audio information, image information, and all personal information. In such an example, transmission of location information, audio information, image information, and all personal information from the information processing apparatus 20 to the server apparatus 30, that is, transmission of those pieces of information to the outside of the vehicle 50, is performed.

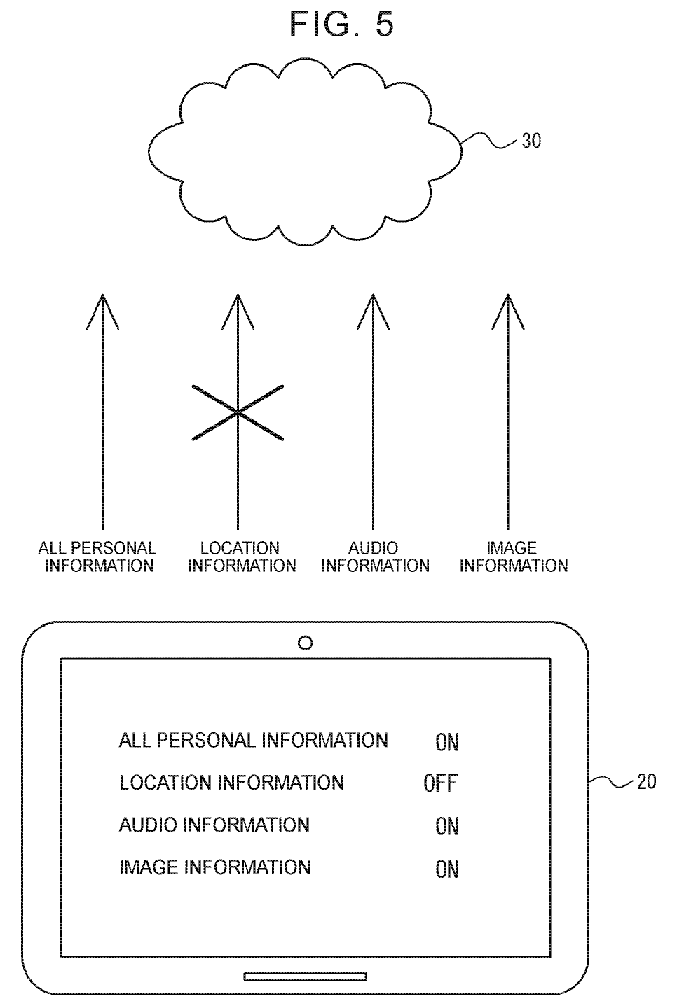

For example, as shown in FIG. 5, it is assumed that the user 11 has disabled transmission of location information. In other words, it is assumed that the user 11 has designated location information as a prohibited type. On the other hand, it is assumed that transmission of audio information, image information, and all personal information remains enabled. In such an example, transmission of location information to the outside of the vehicle 50 is stopped. On the other hand, transmission of audio information, image information, and all personal information to the outside of the vehicle 50 continues to be performed.

In the present embodiment, which function is restricted is defined depending on which type of personal information is disabled for transmission. Thus, it is possible to restrict a portion of the functions of the vehicle 50 according to the type of information selected by the user 11 to be prohibited from being transmitted to the outside of the vehicle 50. By clearly defining the restricted functions and showing the restricted functions to the user 11, it is also possible to ensure transparency in handling of personal information.

For example, the following functions are functions that transmit location information to the server apparatus 30 to cooperate with the server apparatus 30 and are restricted when transmission of location information is disabled. The entirety of the function may be stopped, or only part of the function, including transmission of location information, may be stopped.

Connected Radio: A function that provides music streaming services and news radio suitable for a region by using location information.

Cloud-Connected Eco: A function that analyzes driving conditions based on location information and fuel efficiency data to support eco-driving.

VUI or Agent: A function that enables voice-operated destination search and region-specific information using location information. "VUI” is an abbreviation for voice-user interface.

Home: A function that acquires weather information at a current location using location information and displays the weather information in a widget.

Navigation: A function that acquires the current location of the vehicle 50 based on location information and draws a map using latitude and longitude information.

e-Care: A function that transmits vehicle data with added location information and remotely monitors the health condition of the vehicle 50.

User Profile: A function that saves and applies set values of the user 11, optimized for each region using location information.

Dashboard Camera: A function that uploads video data with added location information to be used as evidence in case of trouble.

The VUI or agent and the dashboard camera are also functions that transmit audio information to the server apparatus 30 to cooperate with the server apparatus 30 and are restricted when transmission of audio information is disabled. The entirety of the function may be stopped, or only part of the function, including transmission of audio information, may be stopped. For example, the VUI or agent may be capable of performing recording and local voice recognition. The dashboard camera may also be capable of performing audio recording.

The dashboard camera is a function that transmits image information to the server apparatus 30 to cooperate with the server apparatus 30 and is restricted when transmission of image information is disabled. The entirety of the function may be stopped, or only part of the function, including transmission of image information, may be stopped. For example, the dashboard camera may also be capable of performing video recording.

For example, the following functions are restricted when transmission of all personal information is disabled. The function itself may be stopped, or only part of the function, including transmission of personal information, may be stopped.

Radio: A function that suggests preferred broadcasting stations by using the channel selection history of the user 11, saved as personal information.

Electronic Owner's Manual: A function that provides a manual suitable for the vehicle 50 based on VIN. "VIN" is an abbreviation for vehicle identification number.

Multimedia Application Log: A function that transmits logs including user operations and viewing history for failure analysis.

Vehicle Graphics: A function that displays a picture of the vehicle 50 on a settings screen based on VIN.

OTA Update: A function that performs software update specific to the vehicle 50 based on VIN. "OTA” is an abbreviation for over-the-air.

Remote Maintenance Mail: A function that transmits diagnostic data of the vehicle 50 and notifies the user 11 of appropriate maintenance information via email.

However, it is desirable that specific functions, such as those that become non-compliant with regulations or violate UBI or corporate vehicle contracts if information is not transmitted to the outside of the vehicle 50, are exempt from restrictions. “UBI” is an abbreviation for usage-based insurance. Whether to be exempt from restrictions may be determined according to a region. For example, the following functions can be exempt from restrictions.

eCall: A function that transmits location information and emergency contact information in case of an accident and automatically requests rescue.

My Car Start Lock: A function that prevents the unauthorized start of the vehicle 50 by verifying the authentication information of registered users.

OBFCM: A function that transmits fuel efficiency data for use in statistics and analysis. "OBFCM” is an abbreviation for On-Board Fuel and/or Energy Consumption Monitoring.

Battery Passport: A function that transmits battery information to enable monitoring and tracking of the status of the battery.

The remote maintenance mail is also considered to be exempt from restrictions according to a region.

The configuration of the information processing apparatus 20 according to the present embodiment will be described with reference to FIG. 1.

The information processing apparatus 20 includes a control unit 21, a storage unit 22, and a communication unit 23.

The control unit 21 includes at least one processor, at least one programmable circuit, at least one dedicated circuit, or any combination of them. The processor is, for example, a general-purpose processor, such as a CPU and a GPU, or a special-purpose processor specialized in a specific process. "CPU” is an abbreviation for central processing unit. "GPU” is an abbreviation for graphics processing unit. The programmable circuit is, for example, an FPGA. "FPGA” is an abbreviation for field-programmable gate array. The dedicated circuit is, for example, an ASIC. "ASIC" is an abbreviation for application specific integrated circuit. The control unit 21 executes a process related to the operation of the information processing apparatus 20 while controlling the units of the information processing apparatus 20.

The storage unit 22 includes at least one semiconductor memory, at least one magnetic memory, at least one optical memory, or any combination of them. The semiconductor memory is, for example, a RAM, a ROM, or a flash memory. "RAM” is an abbreviation for random access memory. "ROM” is an abbreviation for read only memory. The RAM is, for example, an SRAM or a DRAM. "SRAM” is an abbreviation for static random access memory. "DRAM” is an abbreviation for dynamic random access memory. The ROM is, for example, an EEPROM. "EEPROM” is an abbreviation for electrically erasable programmable read only memory. The flash memory is, for example, an SSD. "SSD” is an abbreviation for solid-state drive. The magnetic memory is, for example, an HDD. "HDD” is an abbreviation for hard disk drive. The storage unit 22 functions as, for example, a main storage device, an auxiliary storage device, or a cache memory. The storage unit 22 stores information used in the operation of the information processing apparatus 20 and information obtained through the operation of the information processing apparatus 20.

The communication unit 23 includes at least one communication module. The communication module is, for example, a module that supports a mobile communication standard, such as LTE, 4G standard, and 5G standard, or a wireless LAN communication standard, such as IEEE 802.11. "LTE” is an abbreviation for Long Term Evolution. "4G” is an abbreviation for 4^{th} generation. "5G" is an abbreviation for 5^{th} generation. "IEEE” is an abbreviation for Institute of Electrical and Electronics Engineers. The communication unit 23 communicates with the server apparatuses 30. The communication unit 23 receives information used in the operation of the information processing apparatus 20 and transmits information obtained through the operation of the information processing apparatus 20.

The functions of the information processing apparatus 20 are implemented by the processor, that is, the control unit 21, running a program according to the present embodiment. In other words, the functions of the information processing apparatus 20 are implemented by software. The program causes a computer to function as the information processing apparatus 20 by causing the computer to execute the operation of the information processing apparatus 20. In other words, the computer executes the operation of the information processing apparatus 20 in accordance with the program to function as the information processing apparatus 20.

The program can be stored in a non-transitory computer-readable medium. The non-transitory computer-readable medium is, for example, a flash memory, a magnetic recording device, an optical disc, a magneto-optical recording medium, or a ROM. The program is distributed by, for example, selling, transferring, or lending a portable medium, such as an SD card, a DVD, and a CD-ROM, in which the program is stored. "SD" is an abbreviation for Secure Digital. "DVD” is an abbreviation for digital versatile disc. "CD-ROM" is an abbreviation for compact disc read only memory. Alternatively, the program may be distributed by storing the program in a storage of a server and transferring the program from the server to another computer. Alternatively, the program may be provided as a program product.

A computer, for example, once stores, in a main storage device, a program stored in a portable medium or transferred from a server. Then, the computer causes a processor to read the program stored in the main storage device and executes a process according to the read program on the processor. The computer may directly read the program from the portable medium and execute a process according to the program. Each time the program is transferred from a server to the computer, the computer may occasionally execute a process according to the received program. The program may be executed by a so-called ASP service in which the program is not transferred from a server to the computer and a function is implemented only by providing an execution instruction and acquiring a result. "ASP” is an abbreviation for application service provider. The program includes information subjected to a process on an electronic computer and similar to a program. For example, data that is not a direct command to a computer and that has a property of defining a process of the computer corresponds to “information similar to a program”.

One or some or all of the functions of the information processing apparatus 20 may be implemented by a programmable circuit or a dedicated circuit serving as the control unit 21. In other words, one or some or all of the functions of the information processing apparatus 20 may be implemented by hardware.

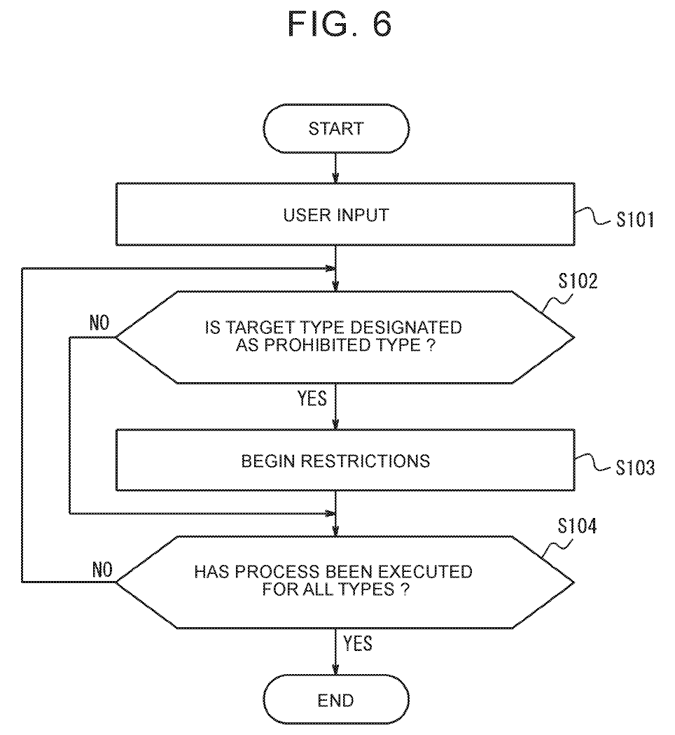

The operation of the information processing apparatus 20 according to the present embodiment will be described with reference to FIG. 6. The operation described below corresponds to a communication restriction method according to the present embodiment. In other words, the communication restriction method according to the present embodiment includes step S101, step S102, step S103, and step S104 shown in FIG. 6.

In S101, the control unit 21 receives, via the input device 52, user input designating types of information to be prohibited as prohibited types from being transmitted to the outside of the vehicle 50.

Specifically, the control unit 21 outputs, via the output device 51, a list of types that can be designated as prohibited types. Then, the control unit 21 receives, via the input device 52, user input selecting whether to designate a type as a prohibited type for each type included in the list. For example, the control unit 21 displays a list that includes four items, that is, location information, audio information, image information, and all personal information, on the display. Then, the control unit 21 receives, via the touch screen, touch input selecting whether to enable or disable transmission for each item included in the list.

In a modification, the control unit 21 may determine, based on a contract regarding the use of the vehicle 50, whether transmission of information of a first type that is a specific type to the server apparatus 30 is mandated. In this modification, when the control unit 21 determines that transmission of information of the first type to the server apparatus 30 is mandated, the control unit 21 excludes the first type from a list to be output. For example, when it is assumed that transmission of location information to the server apparatus 30 has been mandated based on the contract of UBI, the control unit 21 displays a list that includes three items, that is, audio information, image information, and all personal information, other than location information, on the display.

In S102, when one of the types that can be designated as prohibited types is set as a target type, the control unit 21 determines whether the target type is designated as a prohibited type in S101. When the control unit 21 determines that the target type is designated as a prohibited type, step S103 is executed. Otherwise, step S104 is executed.

In S103, the control unit 21 begins to restrict the connected functions that transmit information of the target type to the server apparatus 30 among the connected functions of the vehicle 50.

Specifically, the control unit 21 restricts the entirety of the connected functions that transmit information of the target type to the server apparatus 30, including a portion of the information of the target type, the portion being a portion not to be transmitted to the server apparatus 30. Alternatively, the control unit 21 may restrict part of the connected functions that transmit information of the target type to the server apparatus 30, excluding a portion of the information of the target type, the portion being a portion not to be transmitted to the server apparatus 30. Alternatively, the control unit 21 may output, via the output device 51, a list of connected functions that transmit information of the target type to the server apparatus 30. Then, the control unit 21 may receive, via the input device 52, user input selecting whether to restrict the entirety of the connected function or part of the connected function for each connected function included in the list. For example, the control unit 21 displays, on the display, a list of functions that are restricted when transmission of information of the target type is disabled. Then, the control unit 21 receives, via the touch screen, touch input selecting whether to restrict the entirety of the function or part of the function for each function included in the list.

In the present embodiment, the plurality of connected functions of the vehicle 50 includes a function that performs route guidance by transmitting location information to the server apparatus 30 in real time to cooperate with the server apparatus 30. In response to receiving user input designating location information as a prohibited type in S101, the control unit 21 restricts at least the function that performs route guidance. For example, when the control unit 21 receives in S101 touch input selecting that transmission of location information is disabled, the control unit 21 begins to restrict the above-described “Navigation".

In the present embodiment, the connected functions of the vehicle 50 further include a function that provides weather guidance by transmitting location information to the server apparatus 30 in real time to cooperate with the server apparatus 30. In response to receiving user input designating location information as a prohibited type in S101, the control unit 21 restricts at least the function that performs weather guidance. For example, when the control unit 21 receives in S101 touch input selecting that transmission of location information is disabled, the control unit 21 begins to restrict the above-described “Home".

In the present embodiment, the plurality of connected functions of the vehicle 50 includes a function that interacts as an agent by transmitting audio information to the server apparatus 30 in real time to cooperate with the server apparatus 30. In response to receiving user input designating audio information as a prohibited type in S101, the control unit 21 restricts at least the function that interacts. For example, when the control unit 21 receives in S101 touch input selecting that transmission of audio information is disabled, the control unit 21 begins to restrict the above-described “VUI” or “Agent”.

In the present embodiment, the plurality of connected functions of the vehicle 50 includes a function that records and saves driving video of the vehicle 50 by transmitting image information to the server apparatus 30 in real time to cooperate with the server apparatus 30. In response to receiving user input designating image information as a prohibited type in S101, the control unit 21 restricts at least the function that records and saves driving video. For example, when the control unit 21 receives in S101 touch input selecting that transmission of image information is disabled, the control unit 21 begins to restrict the above-described “Dashboard Camera".

In the present embodiment, the plurality of connected functions of the vehicle 50 includes a function that suggests maintenance of the vehicle 50 by transmitting vehicle information to the server apparatus 30 in real time to cooperate with the server apparatus 30. In response to receiving user input designating vehicle information as a prohibited type in S101, the control unit 21 restricts at least the function that suggests maintenance. For example, when the control unit 21 receives in S101 touch input selecting that transmission of all personal information is disabled, the control unit 21 begins to restrict the above-described “Remote Maintenance Mail".

After S103, step S104 is executed.

In S104, the control unit 21 determines whether step S102 has been executed for all types that can be designated as prohibited types. When the control unit 21 determines that step S102 has been executed for all types, the flow shown in FIG. 6 ends. Otherwise, step S102 is executed for the remaining types.

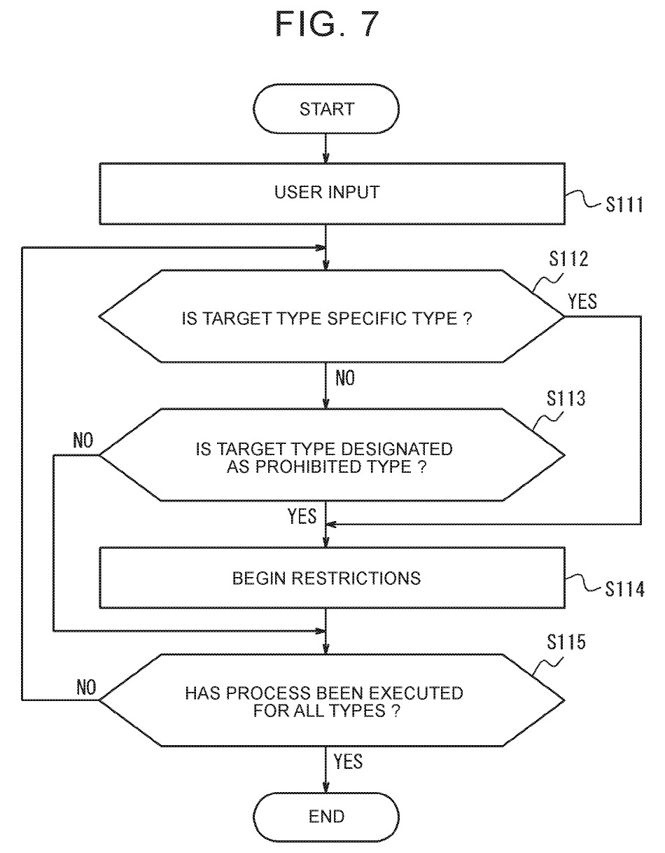

A modification of the operation of the information processing apparatus 20 according to the present embodiment will be described with reference to FIG. 7. The operation described below corresponds to a modification of the communication restriction method according to the present embodiment. In other words, the modification of the communication restriction method according to the present embodiment includes step S111, step S112, step S113, step S114, and step S115 shown in FIG. 7.

Step S111 is similar to step S101 shown in FIG. 6, so the description is omitted.

In S112, when one of the types that can be designated as prohibited types is set as a target type, the control unit 21 determines whether the target type is a second type that is a specific type.

Specifically, the control unit 21 identifies the country where the vehicle 50 is used by referring to country information prestored in the storage unit 22 or location information acquired through the positioning device 55. Then, the control unit 21 determines whether the target type corresponds to the second type in the country where the vehicle 50 is used by referring to the definition of the second type prestored in the storage unit 22 for each country code. For example, when the target type is image information and image information is designated as the second type corresponding to country code "C”, the control unit 21 determines that the target type is the second type when the control unit 21 determines that the country where the vehicle 50 is used is Country C. When the control unit 21 determines that the target type is the second type, step S114 is executed. Otherwise, step S113 is executed.

In step S113, the control unit 21 determines whether the target type is designated as a prohibited type in S111. When the control unit 21 determines that the target type is designated as a prohibited type, step S114 is executed. Otherwise, step S115 is executed.

Step S114 is similar to step S103 shown in FIG. 6, so the description is omitted. After S114, step S115 is executed.

In S115, the control unit 21 determines whether step S112 has been executed for all types that can be designated as prohibited types. When the control unit 21 determines that step S112 has been executed for all types, the flow shown in FIG. 7 ends. Otherwise, step S112 is executed for the remaining types.

As described above, in the example shown in FIG. 7, when the control unit 21 determines that the region where the vehicle 50 is used is a region where transmission of information of the second type to the outside of the vehicle 50 is prohibited, the control unit 21 restricts the connected functions that transmit the information of the second type to the server apparatus 30, without receiving user input designating the second type as a prohibited type. Therefore, according to this example, it is possible to partially restrict transmission of information to the outside of the vehicle 50 additionally according to a situation of a region.

The disclosure is not limited to the above-described embodiment. For example, two or more blocks shown in the block diagram may be integrated or one block may be divided. Instead of executing two or more steps described in the flowchart in time sequence in accordance with the description, the steps may be executed in parallel or in different order in accordance with the processing capacity of an apparatus that executes the steps, or as needed. Modifications are possible without departing from the purport of the disclosure.

Hereinafter, some embodiments of the disclosure will be described. However, embodiments of the disclosure are not limited to these embodiments.

### Addendum 1

A vehicle configured to communicate with an external server apparatus includes: a positioning device; a microphone; a camera; various sensors; an input device; and a computer configured to collect two or more types of information from among four types of information including location information, audio information, image information, and vehicle information respectively obtained through the positioning device, the microphone, the camera, and the various sensors, control a plurality of connected functions that transmits in real time pieces of information respectively corresponding to the plurality of connected functions, from among the collected two or more types of information, to the server apparatus to cooperate with the server apparatus, and, in response to receiving, via the input device, user input designating a type of information to be prohibited from being transmitted to an outside of the vehicle as a prohibited type, restrict the connected function that transmits information of the prohibited type to the server apparatus among the plurality of connected functions.

### Addendum 2

An information processing apparatus includes a control unit configured to control a plurality of connected functions of a vehicle configured to communicate with an external server apparatus, the plurality of connected functions being configured to transmit, to the server apparatus, pieces of information respectively corresponding to the plurality of connected functions from among two or more types of information collected by the vehicle to cooperate with the server apparatus, the control unit being configured to, in response to receiving, via an input device mounted on the vehicle, user input designating a type of information to be prohibited from being transmitted to an outside of the vehicle as a prohibited type, restrict the connected function that transmits information of the prohibited type to the server apparatus among the plurality of connected functions.

### Addendum 3

In the information processing apparatus according to Addendum 2, the control unit is configured to restrict an entirety of the connected function that transmits information of the prohibited type to the server apparatus, and the entirety of the connected function includes a function that transmits a portion of the information of the prohibited type, the portion being a portion not to be transmitted to the server apparatus.

### Addendum 4

In the information processing apparatus according to Addendum 2, the control unit is configured to restrict part of the connected function that transmits information of the prohibited type to the server apparatus, and the part of the connected function is a function that transmits transmit a portion of the information of the prohibited type, the portion being a portion to be transmitted to the server apparatus.

### Addendum 5

In the information processing apparatus according to Addendum 2, the control unit is configured to output, through an output device mounted on the vehicle, a list of connected functions that transmit information of the prohibited type to the server apparatus, and receive, via the input device, user input selecting whether to restrict an entirety of the connected function or part of the connected function for each of the connected functions included in the list.

### Addendum 6

In the information processing apparatus according to any one of Addenda 2 to 5, the control unit is configured to determine whether a region where the vehicle is used is a region where information of a specific type is prohibited from being transmitted to the outside of the vehicle, and, when the control unit determines that the region where the vehicle is used is a region where the information of the specific type is prohibited from being transmitted to the outside of the vehicle, restrict the connected function that transmits the information of the specific type to the server apparatus, without receiving user input designating the specific type as the prohibited type, the information of the specific type being included in the two or more types of information.

### Addendum 7

In the information processing apparatus according to any one of Addenda 2 to 6, the control unit is configured to output, through an output device mounted on the vehicle, a list of types allowed to be designated as the prohibited type.

### Addendum 8

In the information processing apparatus according to Addendum7, the control unit is configured to determine, based on a contract regarding a use of the vehicle, whether transmission of information of a specific type to the server apparatus is mandated, the information of the specific type being included in the two or more types of information, and, when the control unit determines, based on the contract regarding the use of the vehicle, that transmission of the information of the specific type to the server apparatus is mandated, exclude the specific type from the list.

### Addendum 9

In the information processing apparatus according to any one of Addenda 2 to 8, the two or more types of information include location information acquired through a positioning device mounted on the vehicle.

### Addendum 10

In the information processing apparatus according to Addendum 9, the plurality of connected functions includes a function that performs route guidance by transmitting the location information to the server apparatus in real time to cooperate with the server apparatus, and the control unit is configured to restrict at least the function that performs route guidance in response to receiving, via the input device, user input designating the location information as the prohibited type.

### Addendum 11

In the information processing apparatus according to Addendum 9 or 10, the plurality of connected functions includes a function that performs weather guidance by transmitting the location information to the server apparatus in real time to cooperate with the server apparatus, and the control unit is configured to restrict at least the function that performs weather guidance in response to receiving, via the input device, user input designating the location information as the prohibited type.

### Addendum 12

In the information processing apparatus according to any one of Addenda 2 to 11, the two or more types of information include audio information acquired through a microphone mounted on the vehicle.

### Addendum 13

In the information processing apparatus according to Addendum 12, the plurality of connected functions includes a function that interacts as an agent by transmitting the audio information to the server apparatus in real time to cooperate with the server apparatus, and the control unit is configured to restrict at least the function that interacts in response to receiving, via the input device, user input designating the audio information as the prohibited type.

### Addendum 14

In the information processing apparatus according to any one of Addenda 2 to 13, the two or more types of information include image information acquired through a camera mounted on the vehicle.

### Addendum 15

In the information processing apparatus according to Addendum 14, the plurality of connected functions includes a function that records and saves a driving video of the vehicle in the server apparatus by transmitting the image information to the server apparatus in real time to cooperate with the server apparatus, and the control unit is configured to restrict at least the function that records and saves the driving video in the server apparatus in response to receiving, via the input device, user input designating the image information as the prohibited type.

### Addendum 16

In the information processing apparatus according to any one of Addenda 2 to 15, the two or more types of information include vehicle information acquired through various sensors mounted on the vehicle.

### Addendum 17

In the information processing apparatus according to Addendum 16, the plurality of connected functions includes a function that suggests maintenance of the vehicle by transmitting the vehicle information to the server apparatus in real time to cooperate with the server apparatus, and the control unit is configured to restrict at least the function that suggests maintenance in response to receiving, via the input device, user input designating the vehicle information as the prohibited type.

### Addendum 18

A system includes: the information processing apparatus according to any one of Addenda 2 to 17; and the server apparatus.

### Addendum 19

A vehicle includes the information processing apparatus according to any one of Addenda 2 to 17.

### Addendum 20

A communication restriction method includes, by an information processing apparatus configured to control a plurality of connected functions of a vehicle configured to communicate with an external server apparatus, the plurality of connected functions being configured to transmit, to the server apparatus, pieces of information respectively corresponding to the plurality of connected functions from among two or more types of information collected by the vehicle to cooperate with the server apparatus, in response to receiving, via an input device mounted on the vehicle, user input designating a type of information to be prohibited from being transmitted to an outside of the vehicle as a prohibited type, restricting the connected function that transmits information of the prohibited type to the server apparatus among the plurality of connected functions.

What is claimed is:

1. A vehicle configured to communicate with an external server apparatus, the vehicle comprising:
a positioning device;
a microphone;
a camera;
various sensors;
an input device; and
a computer configured to
collect two or more types of information from among four types of information including location information, audio information, image information, and vehicle information respectively obtained through the positioning device, the microphone, the camera, and the various sensors,
control a plurality of connected functions that transmits in real time pieces of information respectively corresponding to the plurality of connected functions, from among the collected two or more types of information, to the server apparatus to cooperate with the server apparatus, and
in response to receiving, via the input device, user input designating a type of information to be prohibited from being transmitted to an outside of the vehicle as a prohibited type, restrict the connected function that transmits information of the prohibited type to the server apparatus among the plurality of connected functions.

2. An information processing apparatus comprising
a control unit configured to control a plurality of connected functions of a vehicle configured to communicate with an external server apparatus, the plurality of connected functions being configured to transmit, to the server apparatus, pieces of information respectively corresponding to the plurality of connected functions from among two or more types of information collected by the vehicle to cooperate with the server apparatus, the control unit being configured to, in response to receiving, via an input device mounted on the vehicle, first user input designating a type of information to be prohibited from being transmitted to an outside of the vehicle as a prohibited type, restrict the connected function that transmits information of the prohibited type to the server apparatus among the plurality of connected functions.

3. The information processing apparatus according to claim 2, wherein:
the control unit is configured to restrict an entirety of the connected function that transmits information of the prohibited type to the server apparatus; and
the entirety of the connected function includes a function that transmits a portion of the information of the prohibited type, the portion being a portion not to be transmitted to the server apparatus.

4. The information processing apparatus according to claim 2, wherein:
the control unit is configured to restrict part of the connected function that transmits information of the prohibited type to the server apparatus; and
the part of the connected function is a function that transmits a portion of the information of the prohibited type, the portion being a portion to be transmitted to the server apparatus.

5. The information processing apparatus according to claim 2, wherein the control unit is configured to
output, to an output device mounted on the vehicle, a list of connected functions that transmit information of the prohibited type to the server apparatus, and
receive, via the input device, second user input selecting whether to restrict an entirety of the connected function or part of the connected function for each of the connected functions included in the list.

6. The information processing apparatus according to claim 2, wherein the control unit is configured to
determine whether a region where the vehicle is used is a region where information of a specific type is prohibited from being transmitted to an outside of the vehicle, and
when the control unit determines that the region where the vehicle is used is a region where the information of the specific type is prohibited from being transmitted to the outside of the vehicle, restrict the connected function that transmits the information of the specific type to the server apparatus, without receiving the first user input designating the specific type as the prohibited type, the information of the specific type being included in the two or more types of information.

7. The information processing apparatus according to claim 2, wherein the control unit is configured to output, to an output device mounted on the vehicle, a list of types allowed to be designated as the prohibited type.

8. The information processing apparatus according to claim 7, wherein the control unit is configured to
determine, based on a contract regarding a use of the vehicle, whether transmission of information of a specific type to the server apparatus is mandated, the information of the specific type being included in the two or more types of information, and
when the control unit determines, based on the contract regarding the use of the vehicle, that transmission of the information of the specific type to the server apparatus is mandated, exclude the specific type from the list.

9. The information processing apparatus according to claim 2, wherein the two or more types of information include location information acquired through a positioning device mounted on the vehicle.

10. The information processing apparatus according to claim 9, wherein:
the plurality of connected functions includes a function that performs route guidance by transmitting the location information to the server apparatus in real time to cooperate with the server apparatus; and
the control unit is configured to restrict at least the function that performs the route guidance in response to receiving, via the input device, the first user input designating the location information as the prohibited type.

11. The information processing apparatus according to claim 9, wherein:
the plurality of connected functions includes a function that performs weather guidance by transmitting the location information to the server apparatus in real time to cooperate with the server apparatus; and
the control unit is configured to restrict at least the function that performs the weather guidance in response to receiving, via the input device, the first user input designating the location information as the prohibited type.

12. The information processing apparatus according to claim 2, wherein the two or more types of information include audio information acquired through a microphone mounted on the vehicle.

13. The information processing apparatus according to claim 12, wherein:
the plurality of connected functions includes a function that interacts as an agent by transmitting the audio information to the server apparatus in real time to cooperate with the server apparatus; and
the control unit is configured to restrict at least the function that interacts in response to receiving, via the input device, the first user input designating the audio information as the prohibited type.

14. The information processing apparatus according to claim 2, wherein the two or more types of information include image information acquired through a camera mounted on the vehicle.

15. The information processing apparatus according to claim 14, wherein:
the plurality of connected functions includes a function that records and saves a driving video of the vehicle in the server apparatus by transmitting the image information to the server apparatus in real time to cooperate with the server apparatus; and
the control unit is configured to restrict at least the function that records and saves the driving video in the server apparatus in response to receiving, via the input device, the first user input designating the image information as the prohibited type.

16. The information processing apparatus according to claim 2, wherein the two or more types of information include vehicle information acquired through various sensors mounted on the vehicle.

17. The information processing apparatus according to claim 16, wherein:
the plurality of connected functions includes a function that suggests maintenance of the vehicle by transmitting the vehicle information to the server apparatus in real time to cooperate with the server apparatus; and
the control unit is configured to restrict at least the function that suggests maintenance in response to receiving, via the input device, the first user input designating the vehicle information as the prohibited type.

18. A system comprising:
the information processing apparatus according to claim 2; and
the server apparatus.

19. A vehicle comprising the information processing apparatus according to claim 2.

20. A communication restriction method comprising
by an information processing apparatus configured to control a plurality of connected functions of a vehicle configured to communicate with an external server apparatus, the plurality of connected functions being configured to transmit, to the server apparatus, pieces of information respectively corresponding to the plurality of connected functions from among two or more types of information collected by the vehicle to cooperate with the server apparatus, in response to receiving, via an input device mounted on the vehicle, user input designating a type of information to be prohibited from being transmitted to an outside of the vehicle as a prohibited type, restricting the connected function that transmits information of the prohibited type to the server apparatus among the plurality of connected functions.
